(19) United States
(12) Patent Application Publication
(10) Pub. No.: US 2024/0190684 A1
(43) Pub. Date: Jun. 13, 2024

(54) SYSTEMS AND METHODS FOR THE LIFTING OF A LOAD

(71) Applicant: Helmerich & Payne Technologies UK Limited, Inverness (GB)

(72) Inventor: Angus Lamberton JAMIESON, Inverness (GB)

(21) Appl. No.: 18/537,660

(22) Filed: Dec. 12, 2023

Related U.S. Application Data
(60) Provisional application No. 63/387,147, filed on Dec. 13, 2022.

(51) Int. Cl. B66C 1/42

(52) U.S. Cl. CPC B66C 1/425

(57) ABSTRACT

Aspects of the present disclosure related to lifting apparatuses and methods for attaching and lifting a load, including for example a lifting apparatus that includes an outer sleeve with first and second openings, an inner unit that has a chamber, a first shear pin, a second shear pin, and an actuation device along with a bar that is positioned within and movable within a track. The bar may also include a projection sized and shaped to engage with a guide in a surface of the outer sleeve. In an unlocked position the first and second shear pins may be disengaged from the first and second openings in the outer sleeve such that the outer sleeve may move relative to the inner unit.

This application claims the benefit of priority of U.S. Provisional Patent Application No. 63/387,147, filed Dec. 13, 2022, and entitled “Systems and Methods for the Lifting of a Load,” which is hereby incorporated by reference as if fully set forth herein.

### FIELD OF THE DISCLOSURE

The present disclosure relates to load lifting systems and in particular systems and methods for controlling the connecting of a load to a lifting device and the lifting and handling of a load.

### BACKGROUND OF THE DISCLOSURE

Loads can be suspended by forklifts, wheel loader overhead cranes such as boom and jib cranes, and many other machines that can lift a load higher than ground level.

Conventional load handling and positioning systems often involve ground workers manually connecting the load to the lifting device. This handling operation can be problematic due to the physically demanding nature of the equipment especially when the work is carried out under adverse weather conditions. Such operations can also involve safety concerns.

Due to the complexity of the handling operation and the safety protocols for the on-site workers, any operation requiring the connection/disconnection and movement of loads must be pre-planned to ensure that at no point a worker is required to work in proximity to the suspended load.

### SUMMARY OF THE DISCLOSURE

It is the object of some aspects of the present disclosure to obviate or at least mitigate the foregoing disadvantages of prior art load lift systems, including load connection systems.

It is an object of some aspects of the present disclosure to provide a system which is designed for easy and rapid connection and disconnection of a load to and from a lifting device.

It is another object of some aspects of the present disclosure to provide a system configured to enable a crane operator to remotely connect and disconnect a lifting device to a load.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and can or cannot represent actual or preferred values or dimensions. Where applicable, some or all features cannot be illustrated to assist in the description of underlying features. In the drawings:

FIG. 1 depicts an example of a pincer grip system, according to various embodiments;

FIGS. 2A-2D depict an engagement sequence of the pincer grip system of FIG. 1 with a lifting load;

FIGS. 2E-2G depict a release sequence of the pincer grip system of FIG. 1;

FIG. 3 depicts another example of a pincer grip system, according to various embodiments;

FIGS. 4A-4B depict an engagement sequence of another example pincer grip system similar to FIG. 1, but differently oriented curved bars;

FIG. 5 depicts a cargo load coupled to four grip systems, according to some embodiments;

FIG. 6 depicts an example of a lifting system that is unattached relative to a load, according to some embodiments;

FIG. 7 depicts a vertical plate with openings of the lifting system of FIG. 6;

FIG. 8 depicts a track of a lifting sleeve of the lifting system of FIG. 6;

FIG. 9 depicts movement of the lifting sleeve of FIG. 8;

FIG. 10 depicts another example of a lifting system that is unattached relative to a load, according to some embodiments;

FIG. 11 depicts an elevation view of the lifting system of FIG. 10, according to some embodiments;

FIG. 12 depicts yet another example of a lifting system, according to some embodiments; and

FIG. 13 depicts an elevation view of the lifting system of FIG. 12, according to some embodiments.

FIG. 14 depicts a lifting system with a manual lock, according to some embodiments.

FIG. 15 depicts another lifting system with a remotely controlled actuator, according to some embodiments.

### DETAILED DESCRIPTION OF THE DISCLOSURE

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described. Referring to the drawings, similar identifiers refer to similar elements.

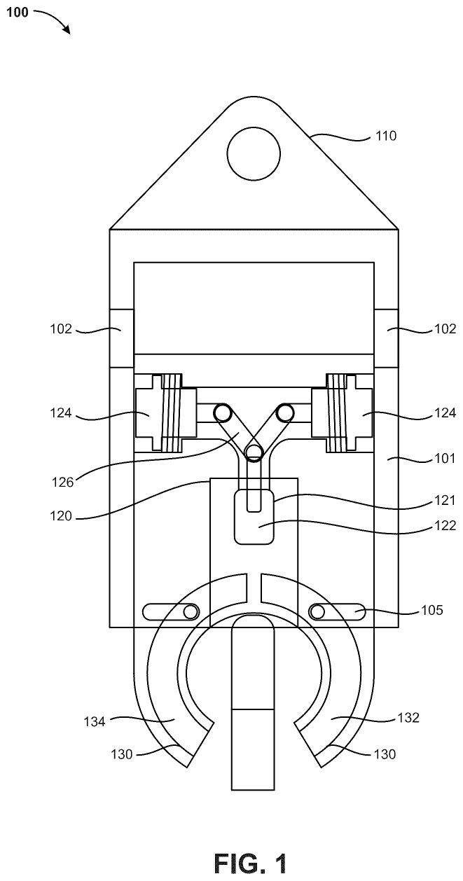

As shown in FIG. 1, a pincer grip system 100 for easy and rapid connection and disconnection of a load to and from a lifting device according to embodiments of the present disclosure can include one or more pincer bars for lifting loads with a pad eye, loop or drilled hole connection point. The pincer grip system 100 can include an outer sleeve 101 coupled to a lifting eye 110. In some embodiments the outer sleeve 101 may be welded to the lifting eye 110, though other forms of attachment may be used including fasteners, adhesives, and any other suitable means of attaching the outer sleeve 101 to the lifting eye 110. The outer sleeve 101 may include one or more openings 102 (shown in FIG. 1 as having two openings) in the sides of the outer sleeve 101. The one or more openings 102 may be drilled, machined, or otherwise formed such that they extend from an inner surface of the outer sleeve through the outer surface of the outer sleeve 101.

The pincer grip system 100 may also include an inner unit 120 that includes a chamber 121. The inner chamber 121 may be sized and shaped to receive an actuation device 122. The actuation device 122 may be a remote-control actuation device. In some embodiments, the actuation device 122 may receive instructions via a wireless connection. It should be noted that using a remotely operated wireless device to control the actuation device may enhance operator safety. As shown in FIG. 1, the actuation device 122 may be a solenoid, though in other embodiments the actuation device 122 may comprise any suitable actuation device 122. The actuation device 122 (shown as a solenoid in FIG. 1) may be coupled to two shear pins 124 by a joint 126, for example via a knuckle joint as shown in FIG. 1, though other means for coupling the actuation device 122 to the shear pins may be used. The shear pins may be under tension when positioned relative to the outer sleeve 101 such that the shear pins are pressed against an inner surface of the outer sleeve 101. For example, in some embodiments one or more springs may apply a force to the shear pins. In some embodiments, more or fewer shear pins may be used. In some embodiments, more or fewer springs may be used.

The pincer grip system 100 may also include a pair of tracks 130 (or recesses), for example curved tracks, shown in FIG. 1, positioned as an end of the pincer grip system 100 opposite the lifting eye 110. Each curved track 130 may receive a curved bar 132, 134. The curved bars 132, 134 may move freely within each respective curved track 130. In some embodiments a different shaped bar and corresponding shaped track may be used. In addition, one or both curved bar 132, 134 may include a projection or stud extending from a surface of the curved bar 132, 134. The outer sleeve 101 may include a pair of slotted guides or holes. Each respective slotted guide may be sized and shaped to receive the projection of a curved bar 132, 134. The slotted guides may guide the movement of the respective curved bars 132, 134 in the curved tracks 130 via engagement with the respective projections. The outer sleeve 101 may move relative to the inner unit 120 such that as the outer sleeve 101 is lowered relative to the inner unit 120, the pair of curved bars 132, 134 are forced along the curved track 130 via the engagement between the projections and the slotted holes, positioning the ends of the pair of curved bars 132, 134 towards one another. The ends of the curved bars 132, 134 may be moved into an overlapping position latching onto a receiving feature of a lifting load (e.g. a pad eye, a loop, or drilled hole connection point). The pincer grip system 100 may be locked with the curved bars 132, 134 secured in their overlapping latch position for securing the pincer grip system 100 to the lifting load. In some embodiments, the bars 132, 134 may be positioned in an overlapping or adjoining position when the pincer grip system 100 is in a locked position for securing to the load to be lifted. In some embodiments, the bars 132, 134 may be positioned in proximal relation to one another when the pincer grip system 100 is in a locked position for securing to the load to be lifted.

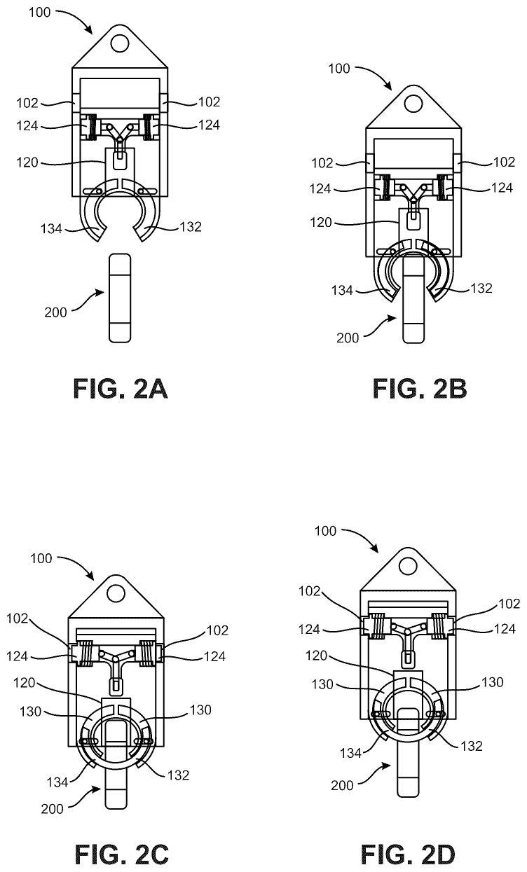

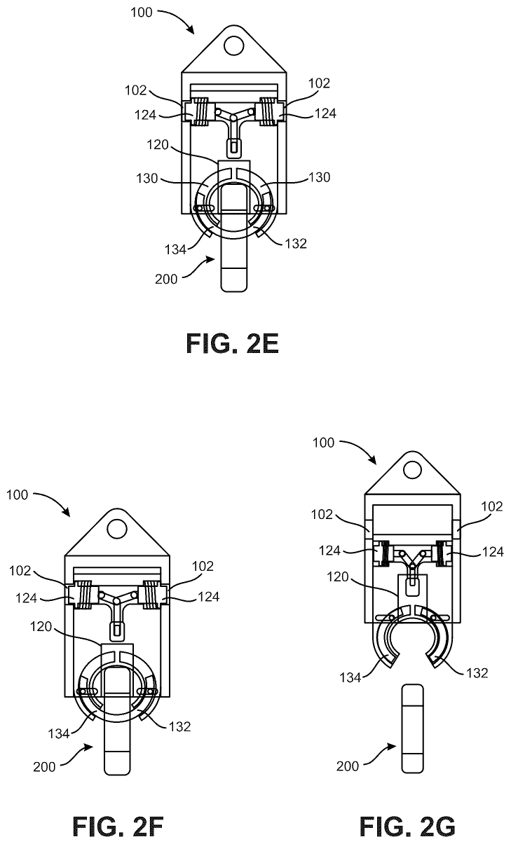

FIGS. 2A-2D depict the engagement sequence of the exemplary pincer grip system 100 depicted in FIG. 1 with a lifting load.

As shown in FIG. 2A, the pincer grip system 100 may be lowered towards a receiving feature 200 of a lifting load. The receiving feature 200 may comprise an eyehole attached to a load, such as at one side or a corner of a cargo container. As the pincer grip system 100 is lowered onto the receiving feature 200, the pincer grip system 100 will come in contact with and eventually shoulder up on top of the receiving feature 200, as shown in FIG. 2B. As the receiving feature 200 contacts the inner unit 120, it prevents the inner unit 120 from dropping further, however the outer sleeve 101 may move relative to the inner unit 120 and therefore may continue to move downwards towards the receiving feature 200. As shown in FIG. 2C, the further movement of the outer sleeve 101 in a downward direction forces each of the curved bars 132, 134 through the respective curved tracks 130 via engagement between the projections and the slotted guides. As the outer sleeve 101 moves in the downward direction (while the inner unit's movement is stopped) the ends of the curved bars 132, 134 eventually at least partially overlap with (or adjoin, or be positioned proximate to) one another such that the curved bars 132, 134 are engaged with the receiving feature 200. Eventually the movement of the outer sleeve 101 in the downward direction brings the shear pins 124 of the inner unit 120 into alignment with each respective opening in the sides of the outer sleeve 101. As the shear pins 124 align with the openings 102 in the outer sleeve 101, the shear pins 124 are forced into and through the respective openings 102 via a spring or other feature, thereby securing the inner unit 120 in place relative to the outer sleeve 101 and locking the curved bars 132, 134 in the secured (or latched or locked) position. In this secured position, with the curved bars 132, 134 engaged with the receiving feature 200, the pincer grip system 100 is a rigid connector which may be lifted and lowered as many times as necessary as shown in FIG. 2D. In addition, the system may include a limit switch which may send a signal to indicate if the actuator or pins are extended through the openings 102 to indicate the curved bars 132, 134 are in the secured position. The signal may be received at a handheld device, and may provide an indication, e.g. a light or other indicator, that the curved bars 132, 134 are in the secured position.

FIGS. 2E-2G depict an exemplary release sequence of the exemplary pincer grip system 100.

When the user is ready to release the pincer grip system 100 from the load to be lifted, the pincer grip system 100 may lower down the lifting load as shown in FIG. 2E. The shear pins retaining the pincer grip system 100 in the secured position may then be retracted from the openings 102 in the outer sleeve 101, for example via a remote (e.g. a wireless) signal, as shown in FIG. 2F. The retraction of the shear pins disengages the outer sleeve 101 from the inner unit 120 such that the inner unit 120 may move relative to the outer sleeve 101. With the shear pins disengaged from the openings 102 in the outer sleeve 101, the curved bars 132, 134 are no longer locked in their latched position and the pincer grip system 100 may be lifted from the lifting load. As shown in FIG. 2G as the pincer grip system 100 is lifted, the outer sleeve 101 may be lifted relative to the inner unit 120 thereby forcing the unlocked curved bars 132, 134 to retract along the curved track 130 via engagement between the projections and the slotted guides. The retraction of the curved bars 132, 134 releases the pincer grip system 100 from the receiving feature 200 of the lifting load. With the curved bars 132, 134 retracted and released or unlatched from the receiving feature 200, the pincer grip system 100 may be lifted clear of the lifting load.

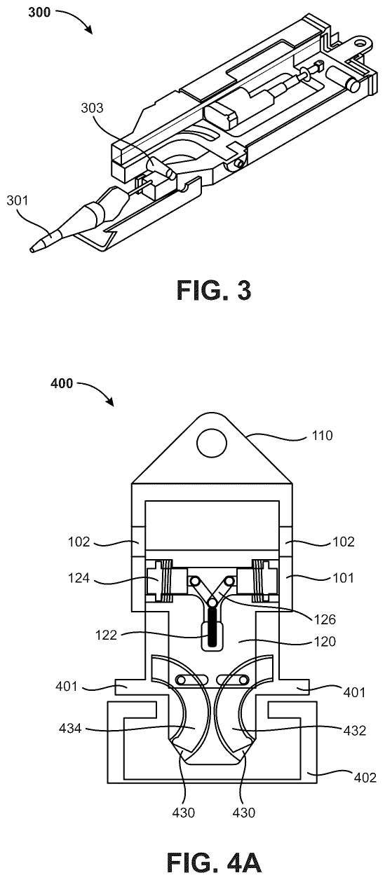

Though the pincer grip system 100 depicted in FIGS. 1-2G above comprises two curved bars 132, 134, embodiments of the present disclosure may include only a first arm that may be sized and shaped such that it may move from an unlatched position into a latched position in which it is positioned within a receiving aperture on a passive arm on an opposite side, for example as shown in the non-limiting example of a pincer system 300 in FIG. 3.

In the non-limiting embodiment depicted in FIG. 3 a spear 301 may extend from the pincer system 303. The spear 301 may aid in positioning the pincer system 303 by positioning the spear 301 within the opening of a box connector of a load (for example a connector at a corner of a shipping container e.g., see FIG. 5). As with the other embodiment provided above, the pincer system 300 may include a limit switch which may send a signal to indicate if the actuator or pins are extended through the openings to indicate the curved bars are in the secured position. The signal may be received by another device, including but not limited to a handheld device (e.g. a mobile phone), and may provide an indication, e.g. a light or other indicator, that the curved bars are in the secured position. In addition, the pincer system 300 may provide a red light or other indication that the pincer system 300 is positioned in a locked position (or alternatively in an unlocked position).

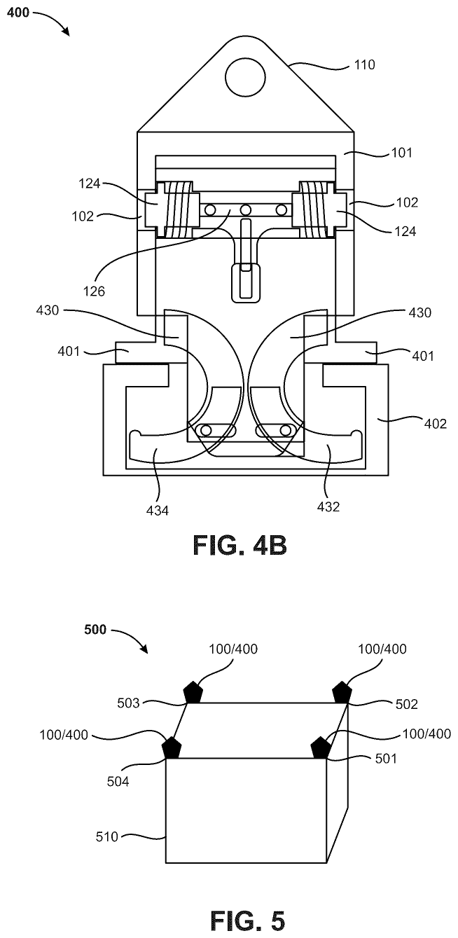

Another embodiment of a system according to aspects of the present disclosure is a grip system 400 shown in FIGS. 4A-4B. The non-limiting exemplary grip system 400 may be a splay grip system and may have much of the same structure and function as the embodiment described above in FIGS. 1-2G though the curved bars and curved tracks 130 are oriented in the opposite direction to form a splay grip system 400 as compared to the pincer grip system 100.

As shown in FIG. 4A, the splay grip system 400 (interchangeably referred as the pincer grip system) according to embodiments of the present disclosure may be lowered to the receiving feature, which may be a box connector of a standard shipping container. A standard shipping container may have a box connector 402 as shown in FIG. 4A in each corner of the shipping container. The outer sleeve 101 of the splay grip system 400 depicted in FIG. 4A includes feet or leg 401 on a bottom region of the splay grip system 400 which may contact the box connector 402. The inner unit 120 may move relative to the outer sleeve 101 when the leg 401 contact the box connector 402 such that the shear pins 124 may move into a position in which they align with the openings 102 in the outer sleeve 101 such that the shear pins 124 are forced through and lock into the openings 102 for positioning the splay grip system 400 in a locked position. The movement of the inner unit 120 relative to the outer sleeve 101 can also force the curved bars 432, 434 along the curved tracks via the projections and guide slots. The curved bars 432, 434 may be forced outwards away from away another such that they become engaged with the box connector 402 as shown in FIG. 4B.

As shown in FIG. 4B the splay grip system 400 is in a locked position, via engagement between the shear pins 124 and the openings 102 in the outer sleeve 101, and becomes a rigid connector which may be lifted and lowered as many times as necessary while remaining engaged with the box connector 402 via the curved bars 432, 434 being locked in a secured position in which they contact and engage with a lip or edge of the box connector 402. One or more splay grip systems (e.g., 400) may be coupled to a load to be lifted to define a lifting assembly.

As described above with respect to the pincer grip system 100 of FIGS. 1-2G, the splay grip system 400 depicted in FIGS. 4A-4B may be actuated from a locked or secured position to an unlocked or unsecured position by actuating the shear pins 124 to disengage them from the openings 102 in the outer sleeve 101. With the shear pins 124 disengaged from the openings 102 in the outer sleeve 101, the splay grip system 400 may be raised and the curved bars 432, 434 may retract into the curved tracks 430 to disengage from the box connector 402 as the splay grip system 400 is lifted, via the engagement between the projections and the guide slots, such that the inner unit 120 moves relative to the outer sleeve 101.

As with the embodiments provided above, the system may include a limit switch which may send a signal to indicate if the actuator or pins are extended through the openings to indicate the system is in the secured position. The signal may be sent and received wirelessly. For example, a handheld device (e.g. a mobile phone) or other device, may provide an indication, e.g. a light or other indicator, that the system is in the secured position or alternatively in the unsecured position. The system may also be controlled remotely (e.g. wirelessly) via a device, including but not limited to via a mobile phone with an application installed thereon for controlling the system. The system may also transmit a wireless signal to a remote device (e.g. a mobile phone or other device) as a warning that the system is in an unlocked position, the signal may be received as an e-mail, a text message, a light/indicator, or other communication.

While the forgoing description and figures depict a pincer grip system 100 and a splay grip system 400 comprising a single connector, multiple systems comprising one or more connectors may be used. For example, a connector system (e.g., 100 and/or 400) may be used to couple to each corner (e.g., 501, 502, 503, 504) of a cargo container (e.g., 500), or at each end of a long beam, precast concrete structure, and other loads that may need to be lifted, moved, and/or set in place. Thus, the disclosure may be particularly useful in construction of buildings, bridges, highways, pipelines, railroads, and the removal and/or installation of heavy equipment. For example, the FIG. 5 depicts a cargo load 500 coupled to four grip systems (e.g., 100 and/or 400), with a grip system 100 coupled to each corner 501-504 of the load 500, which could be among other loads a cargo container or a precast concrete structure.

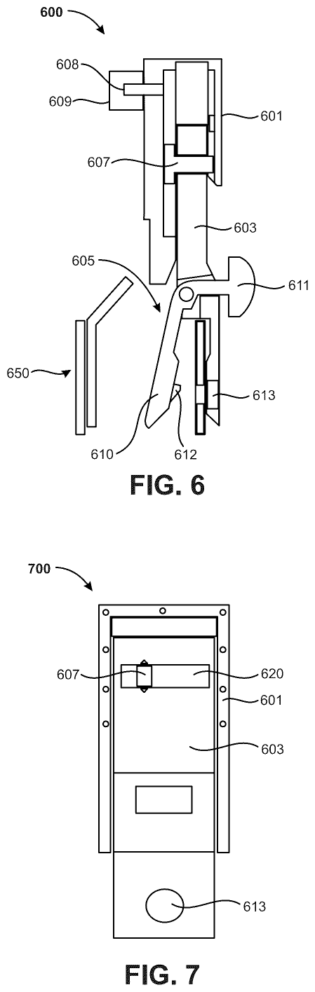

In other aspects of the present disclosure, a lifting system is provided as described below and depicted in FIG. 6-9. In FIG. 6, a lifting system 600 is shown unattached relative to a load, namely a box section 650. Though only a single lifting system and a single box section is depicted, it is understood that a load may including a plurality of box sections positioned at various points along the load (for example but not limited to at each corner of a load container) and that a lifting system according to embodiments of the present disclosure may be used to couple or secure to each of the plurality of box sections of a container, or other loads (including but not limited to an irregular shaped load). The lifting system 600 comprises a sleeve 601, namely lifting sleeve, a vertical plate 603, a grip 605, namely pincer grip, a shear stud 607, a latch 609, and a lifting hole. The lifting sleeve 601 may move relative at least some of the other features of the lifting system 600, including for example the vertical plate 603. The vertical plate 603 is positioned within a chamber in the lifting sleeve 601 such that a first arm and a second arm of the lifting sleeve 601 each partially surround the vertical plate 603. The vertical plate 603 has an opening, cut-out, or aperture sized and shaped to receive shear stud 607. The shear stud 607 may move in a lateral direction within the aperture of the vertical plate 603. The vertical plate 603 may also include an opening, cut-out, or aperture sized and shaped to receive the pincer grip 605. The pincer grip 605 may be mounted and pinned to the vertical plate 603 such that a latching arm 610 of the pincer grip 605 may pivot vertically through a small angle relative to a rear portion 611 of the pincer grip 605 and the vertical plate 603.

The latching arm 610 may further include a projection 612 or stud, namely lifting stud 612. The lifting stud 612 may be sized and shaped to extend through an opening, cut-out, or aperture proximate a top region of the box section 650. Thus, the latching arm 610 may pivot or rotate relative to the vertical plate 603 and the box section 650 from an unlatched position in which the lifting stud 612 does extend through the aperture in the box section 650, to a latched position in which the lifting stud 612 extends through the aperture thereby securing the box section 650 to the pincer grip 605. The vertical plate 603 may also include a viewing aperture 613 positioned and sized to allow for visual confirmation that the lifting stud 612 has engaged with the opening in the box section 650.

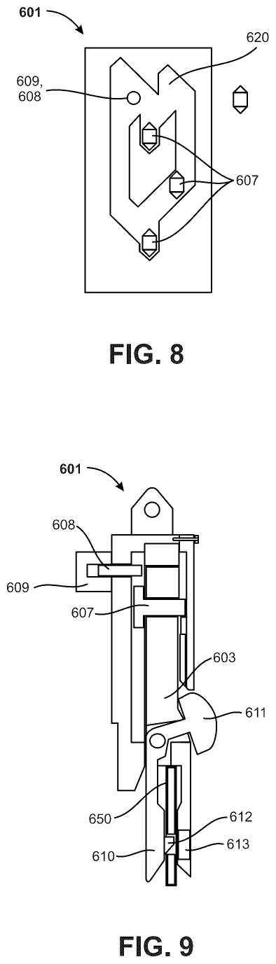

In FIG. 7 provided, the vertical plate 603 is shown with the openings visible for receiving a bolt 608, the latching arm 610, and the shear stud 607. The lifting sleeve 601 has a track 620 (schematic depicted in FIG. 8) which may receive the shear stud 607.

The shear stud 607 may move within the track 620 in response to the positioning of the lifting sleeve 601. The latch 609 may include a control apparatus that controls the position of a latching feature, for example but not limited to a bolt 608. The bolt 608 may be positioned in a projected position in which it extends into the track 620 in the lifting sleeve 601. As described in further detail below, the bolt 608 can block a portion of the track 620 for preventing the shear stud 607 from entering a portion of the track 620. For example, the bolt 608 can block and prevent the shear stud 607 from entering a release portion of the track 620 corresponding to the movement of the bolt 608 when the pincer grip 605 is released or uncoupled from the box section 650. The bolt 608 may also be positioned in a retracted position in which it does not extend into the track 620 thereby allowing the shear stud 607 to slide within all portions of the track 620, including the release portion. The control apparatus may be a remote-control apparatus that may control the position of the bolt 608 from a remote location. For example, the control apparatus may be a remote-controlled solenoid that may control the actuation or position of the bolt 608. In particular, the control apparatus may retract or withdraw the bolt 608 from a latched or secured position in which the bolt 608 extends into the track 620 in which it prevents the shear stud 607 from entering the release portion of the track 620. With the bolt 608 withdrawn from the track, the shear stud 607 may move through the release portion of the track 620 such that the pincer grip 605 may release or uncouple from the box section 650 as described further below.

As shown in FIG. 9, under the effects of gravity, the lifting system continues to move in a downward direction as indicated by arrow ‘A’, the lifting sleeve 601 moves in the downward direction toward the box section 650 relative to the vertical plate 603. As the lifting sleeve 601 is lowered, the shear stud 607 slides along the track 620 in the lifting sleeve 601. With the bolt 608 in the retracted position, as the lifting sleeve 601 is lowered, the shear stud 607 may move in an upwards direction (relative to the lifting sleeve 601) to towards the lifting hole of the lifting system. As the lifting sleeve 601 lowers, an end of the first arm the lifting sleeve 601 may contact the latching arm 610 of the pincer grip 605. The application of force by the first end of the lifting sleeve 601 on the latching arm 610, under the effect of gravity, may force the latching arm 610 to rotate toward the box section 650 and move the latching arm 610 from the unlatched position to the latched position in which the lifting stud 612 extends through the aperture thereby securing the box section 650 to the pincer grip 605.

With the latching arm 610 in the latched position, the rear portion 611 comes into contact with an end 50 of the second arm of the lifting sleeve 601 preventing the lifting sleeve 601 from moving further towards the box section 650. In addition, when the latching arm 610 is in the latched position with the lifting stud 612 projecting through the aperture, the bolt 608 is positioned in the track 620 to prevent the shear stud 607 from entering the release region of the track 620. The position of the bolt 608 in the track 620 further secures the lifting sleeve 601 and the vertical plate 603 relative to one another such that the lifting system is secured in a latched position in which the lifting stud 612 is positioned within the aperture and the system may be lifted without the lifting stud releasing from the aperture.

In the latched position in which the load is lifted via the coupling between the lifting system and the box section 650, the guide stud 612 is in a location in the track 620 where the lifting sleeve 601 is limited in movement and cannot release the shear pin from the aperture. Thus, in the latched position, the load may be lifted and the lifting stud 612 remains secured to the box section 650 via engagement with the aperture. Moreover, the lifting sleeve 601 remains locked relative to the vertical plate 603 via the engagement of the shear stud 607 and the position of the bolt 608.

To release the lifting system 600, the system may be lowered such that the load rests on a surface. With the load positioned on the surface, the lifting system remains secured to the load via engagement between the lifting stud 612 and the aperture, as described above. To release the lifting system from the box section 650, with the load resting on a surface, the latch 609 is actuated to retract the bolt 608 from the track 620 to position the bolt 608 in the withdrawn position. The bolt 608 may be withdrawn or retracted by actuating the control apparatus. The control apparatus may be actuated remotely, though in some embodiments the control apparatus may alternatively or additional be controlled manually at its location. In some embodiments, the control apparatus may be a remote-control apparatus that may be controlled via a wireless communication. For example, in some embodiments control apparatus may be a remote-controlled solenoid that may actuate the bolt 608 between the extended and retracted positions in response to a wireless signal or communication. The wireless signal or communication may include, but is not limited to, an electronic signal, a pneumatic signal, a magnetic signal, a wireless signal communication according to Bluetooth or another wireless communication protocols, or any other suitable wireless communication. In some embodiments, the control apparatus may be controlled using a wired communication link. In some embodiments, the control apparatus may be actuated by a mechanical switch, lever, or other mechanical feature. In some embodiments, the bolt 608 may be manually actuated between the extended and retracted positions.

With the bolt 608 in the retracted position in which it does not extend into the track 620 as the lifting system is briefly lowered further to send the guide stud into the release track. The lifting sleeve 601 may move in the downward direction under the effects of gravity allowing the bolt 608 to slide within the track 620 and the lifting sleeve 601 may be subsequently lifted or pulled upwards which lifts the lifting sleeve 601 and releases the latching arm 610 from its engagement with the top of the cabin box section. As with the other embodiments provided above, the system may include a limit switch which may send a signal to indicate if the latching arm 610 is in the secured/latched position or unlatched position. The signal may be received at a handheld device, and may provide an indication, e.g. a light or other indicator, that the latching arm 610 in the secured position or the unsecured position.

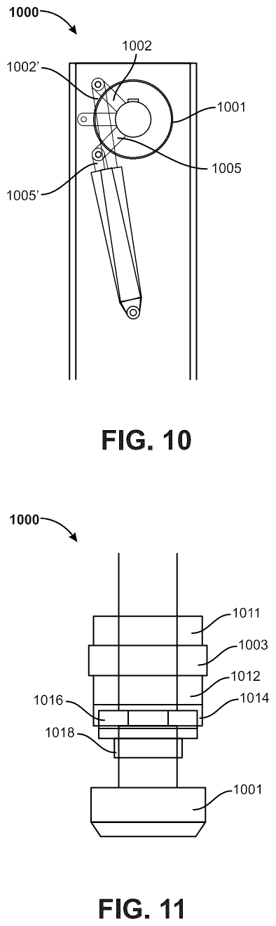

In still yet another embodiment of a lifting system 1000 is contemplated by the present disclosure. The lifting system 1000 comprises an actuator 1005, a lever 1002, a locking body 1001, and a gear 1003, for example as shown in FIG. 10.

The locking body 1001 can be sized and shaped to fit within an opening in a load to be lifted. The load to be lifted may include a standard ISO cast chamber in a corner (or other suitable location) of a shipping container, for example a container that complies with ISO standard 1161 (2016), which is incorporated in its entirety herein by reference. The opening in the container (i.e. the load) may be a chamber that is generally oblong in shape and into which the locking body 1001 can extend. The locking body 1001 can have a size and shape that permits the locking body 1001 to be positioned at least partially in the chamber of the container. The locking body 1001 can be sized and shaped such that when positioned within the chamber, the locking body 1001 may be rotated such that it becomes securely engaged or locked within the chamber. For example, without limitation, the locking body 1001 may have a shape that is oblong, generally oblong, generally rectangular, or otherwise suitable shaped to engage with the sides/walls/surfaces of the chamber of the container such that the locking body 1001 is secured within the chamber and may not be retracted from the chamber when in this secured position.

The actuator 1005 of the lifting system 1000 may control the position or rotation of the locking body 1001. The actuator 1005 may be controlled remotely in some embodiments. The actuator 1005 may be a piston, for example, that may extend or retract in length. The actuator 1005 may be coupled to a lever 1002 that is in turn coupled to the locking body 1001 for controlling the position of the locking body 1001 (e.g. rotating the locking body 1001) in response to the movement of the actuator 1005. The lever 1002 may be coupled to the locking body 1001 via a gear 1003. The actuator 1005 may move between a first position that corresponds to the locking body 1001 being in an unlocked position in which it may be positioned within the chamber of the container, to a second position which corresponds to the locking body 1001 being in a secured position in which it is locked or secured within the chamber. The length of the actuator 1005, the lever 1002, and the position of the gear 1003 relative to the actuator 1005 and lever 1002 may be selected to correspond with the size, orientation, and location of the chamber relative to the boundaries of the container such that the elements of the lifting system do not extend beyond the edges of the container.

A non-limiting exemplary elevation view of a lifting system 1100 is provided in FIG. 11. Though multiple elements (e.g., nut 1011, gear 1103, spacer 1012, split collet and retainer 1014, thrust washer 1016, bearing bush 1018 etc.) are provided in the exemplary lifting system 1100, more or fewer elements may be used. The locking body 1101 is shown in a locked position in which it may engage with the surfaces of a chamber to secure or lock the lifting system 1100 to the container/load.

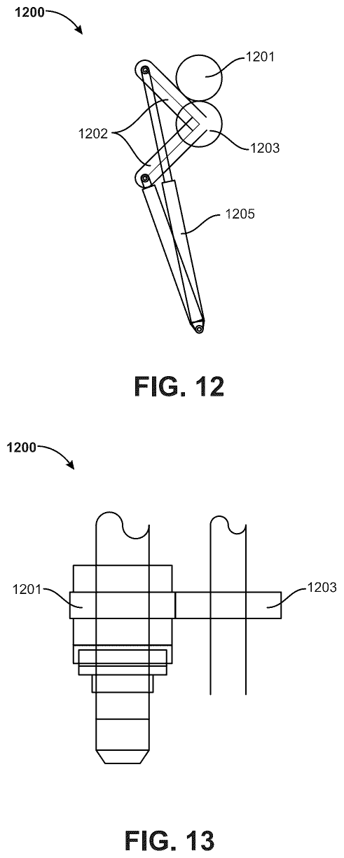

In still yet another embodiment, a lifting system 1200 may include two gears 1201, 1203, as depicted in the non-limiting exemplary embodiment in FIG. 12 and FIG. 13.

A schematic of the lifting system 1200 in an unlocked or unsecured position in which the locking body may be inserted into or removed from the chamber of the container/load. Though multiple elements (e.g., nut, two gears, spacer, split collet and retainer, thrust washer, bearing bush etc.) are provided in the exemplary lifting system 1200, more or fewer elements may be used. The locking body is shown, in FIG. 12, in an unlocked or unsecured position in which it may be inserted into or removed from the chamber of a container/load.

According to some aspects of the present disclosure, limit switches may be included in the lifting system to detect and report the position of the lifting system (e.g. locked/secured vs. unlocked/unsecured back to another device (e.g. a handset). Moreover, the lifting system may be controlled remotely via a device (e.g. the handset) such that the lifting system may be locked/unlocked via a remote device and the position of the lifting system (e.g. locked vs. unlocked) may be provided to the remote device. For example, in some aspects, a red light on a device may indicate the lifting system is unlocked while a green light may indicate that the lifting system is in the locked position in which it is secured to the container/load.

The apparatus, comprising one or more lifting systems according to the present disclosure) and method may be safer than previous systems which require on-site workers manually connecting the load to the lifting device and controlling its orientation by guide ropes or working in close proximity to the suspended load. By providing a system that enables remote connection and disconnection of a load and minimizes stresses and strains on the connection, The apparatus and method mitigates potential damage and/or personnel injuries. For example, one or more lifting systems of a load lifting apparatus may be controlled remotely (e.g. wirelessly) via a device. The device may include but it not limited to a mobile phone. In some aspects, the device may be a part of another device, for example a crane or other lifting device. In some aspects, the device may be a mobile device, for example a device having an application thereon for controlling one or more lifting systems. In some aspects, one or more lifting systems may transmit a wireless signal to the device or to a different device to indicate the position of the one or more lifting systems (e.g. locked or unlocked). The wireless signal may correspond to a light, an email, a text message, or other form of communication. The wireless signal may be received by the device that controls the one or more lifting systems, or may be received by another device.

It should be noted that the foregoing disclosure describes how a number of the disclosed embodiments may be used with containers, such as standard cargo containers that typically include standardized lifting openings at each corner thereof. In fact, it is believed that all of the foregoing embodiments can be used in connection with such containers. It should also be noted, however, that the size and shape of the connecting devices and lifting systems disclosed herein may be adapted to work with other lifting features of containers and other loads to be lifted, including loads with irregular shapes, such as precast concrete structures for roads or for buildings or other structures, steel or iron I-beams, building materials and features, pressure vessels, and so forth. It is to be further noted that the foregoing description focuses on connecting the lifting system to a load to be lifted, but once lifted, the foregoing systems are also advantageous in allowing an operator to move and lower the load, and then disconnect the lifting system from the load once the load has been moved to and placed in a selected location and/or orientation. Just as with lifting the load, the lifting system is helpful because an operator can use the lifting system to lower the load and disconnect the same from the lifting system from a remote location, thereby increasing operator safety in the lowering and disconnecting steps as well as the lifting steps.

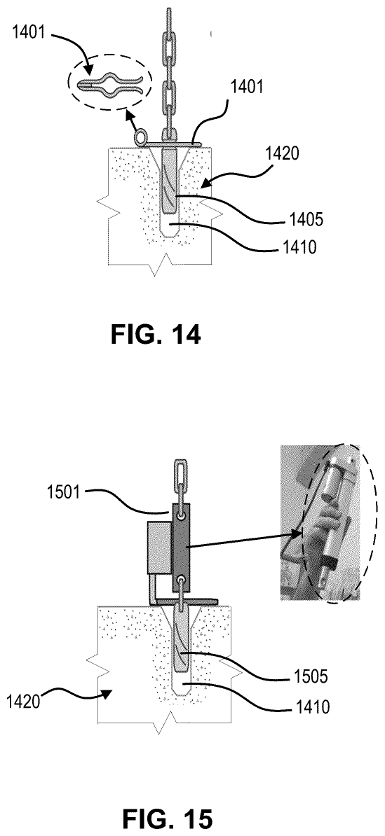

FIG. 14 depicts a lifting system with a manual lock 1401, according to some embodiments. The manual lock 1401 can be coupled to a lifting plate 1405 positioned in the machined inset 1410 in a load 1420. Once the manual lock 1401 is securely engaged with the lifting plate 1405, the load 1420 can be lifted (e.g., via a chain, rope, pulley, or other lifting means).

FIG. 15 depicts another lifting system with a remotely controlled actuator, according to some embodiments. The actuator 1501 can be coupled to a lifting plate 1505 positioned in the machined inset 1410 in a load 1420. Once the actuator 1501 is securely engaged with the lifting plate 1505, the load 1420 can be lifted (e.g., via a chain, rope, pulley, or other lifting means). The actuator 1501 can include a cylinder-piston arrangement with solenoid that can be remotely actuated to unlock from the lifting plate 1425. Other remote actuation means are possible. The actuator 1501 can be mounted to the lifting plate 1505 above a spear, as discussed herein, locking the load 1420 in a lift position until remotely released.

### Examples

A collection of exemplary embodiments, including at least some explicitly enumerated as “Examples” providing additional description of a variety of example types in accordance with the concepts described herein are provided below. These examples are not meant to be mutually exclusive, exhaustive, or restrictive; and the present disclosure is not limited to these example examples but rather encompasses all possible modifications and variations within the scope of the issued claims and their equivalents.

Example 1. A lifting apparatus comprising: an outer sleeve having a first opening in a first side of the outer sleeve and a second opening in a second side of the outer sleeve; an inner unit further comprising: a chamber; a first shear pin; a second shear pin; an actuation device coupled to the first and second shear pins for actuating the first and second shear pins from an extended to a retracted position; and a bar positioned within and movable within a track, the bar further comprising a projection sized and shaped to engage with a slotted guide in a surface of the outer sleeve, wherein in an unlocked position in which the first and second shear pins are disengaged from the first and second openings in the outer sleeve, the outer sleeve may move relative to the inner unit.

Example 2. The lifting apparatus of any of the preceding or subsequent examples or combination of examples, wherein the bar is a semi-circular bar.

Example 3. The lifting apparatus of any of the preceding or subsequent examples or combination of examples, the inner unit further comprising a passive arm having a receiving aperture sized and shaped to receive the bar.

Example 4. The lifting apparatus of any of the preceding or subsequent examples or combination of examples, the inner unit further comprising an additional bar positioned and movable within an additional track, the additional bar further comprising an additional projection sized and shaped to engage with an additional slotted guide in a surface of the outer sleeve, wherein the bar and the additional are each semi-circular in shape.

Example 5. The lifting apparatus of any of the preceding or subsequent examples or combination of examples, the inner unit further comprising a first spring coupled to the first shear pin for applying a force to the first shear pin, and a second spring coupled to the second shear pin for applying a force to the second shear pin.

Example 6. The lifting apparatus of any of the preceding or subsequent examples or combination of examples, wherein in a locked position in which the first and second shear pins are engaged with the first and second openings in the outer sleeve, the outer sleeve may not move relative to the inner unit and the bar is locked in a latched position.

Example 7. The lifting apparatus of any of the preceding or subsequent examples or combination of examples, wherein in a locked position in which the first and second shear pins are engaged with the first and second openings in the outer sleeve, the outer sleeve may not move relative to the inner unit and an end of the bar overlaps with an end of the additional bar in a latched position.

Example 8. The lifting apparatus of any of the preceding or subsequent examples or combination of examples, wherein in the locked position a concave curve of the bar faces in an opposing direction from a concave curve of the additional bar such that a first end of the bar is engageable with a first lip of a box connector and a first end of the additional bar is engageable with a second lip of the box connector.

Example 9. The lifting apparatus of any of the preceding or subsequent examples or combination of examples, further comprising a transmitter for transmitting a wireless signal to a device, wherein the wireless signal corresponds to an indication of a locked or an unlocked position of the lifting apparatus.

Example 10. The lifting apparatus of any of the preceding or subsequent examples or combination of examples, further comprising a receiver for receiving a wireless signal from a device, wherein the wireless signal corresponds to an instruction for controlling the position of the lifting apparatus between a locked or an unlocked position.

Example 11. The lifting apparatus of any of the preceding or subsequent examples or combination of examples, wherein the device is a mobile phone.

Example 12. The lifting apparatus of any of the preceding or subsequent examples or combination of examples, wherein the device is a computing device that is part of a heavy machinery apparatus.

Example 13. The lifting apparatus of any of the preceding or subsequent examples or combination of examples, wherein the heavy machinery apparatus is a crane.

Example 14. A lifting system comprising: a first lifting apparatus comprising: a first outer sleeve having a first opening in a side of the first outer sleeve; a first inner unit having a first chamber, a first shear pin, a first actuation device coupled to the first shear pin for actuating the first shear pin from a locked to an unlocked position, and a first grip for coupling to a first connector of a load, wherein in the unlocked position the first shear pin is disengaged from the opening in the first outer sleeve such that the first outer sleeve may move relative to the first inner unit; a second lifting apparatus comprising a second outer sleeve having a second opening in a side of the second outer sleeve; a second inner unit having a second chamber, a second shear pin, a second actuation device coupled to the second shear pin for actuating the second shear pin from a locked to an unlocked position, and a second grip for coupling to a second connector of a load, wherein in the unlocked position the second shear pin is disengaged from the opening in the second outer sleeve such that the second outer sleeve may move relative to the second inner unit.

Example 15. The lifting system of any of the preceding or subsequent examples or combination of examples, further comprising: a third lifting apparatus comprising a third outer sleeve having a third opening in a side of the third outer sleeve; a third lifting apparatus comprising: a third inner unit having a third chamber, a third shear pin, a third actuation device coupled to the third shear pin for actuating the third shear pin from a locked to an unlocked position, and a third grip for coupling to a third connector of a load, wherein in the unlocked position the third shear pin is disengaged from the third opening in the third outer sleeve such that the third outer sleeve may move relative to the third inner unit.

Example 16. A method for attaching and lifting a load comprising: lowering a lifting system comprising a lifting apparatus onto a load; positioning an inner unit of the lifting apparatus onto the load such that the inner unit is blocked from moving further in a downward direction; continuing to lower an outer sleeve of the lifting system as the inner unit is retained in place by the load; automatically securing a grip of the lifting apparatus to a connector of the load; automatically actuating a shear pin from a released position to a locked position in which the shear pin projects into an opening in the outer sleeve of the lifting apparatus for securing the grip of the lifting apparatus to the connector of the load; and lifting the load by lifting the lifting system.

Example 17. The method of any of the preceding or subsequent examples or combination of examples, further comprising: positioning the load on a surface; actuating the shear pin from the locked position to the released position in which the shear pin does not project into the opening in the outer sleeve of the lifting apparatus; automatically disengaging the grip of the lifting system from the connector of the load by lifting the lifting apparatus in a vertical direction.

Example 18. The method of any of the preceding or subsequent examples or combination of examples, wherein the lifting system comprises an additional lifting apparatus for coupling to the load.

Example 19. The method of any of the preceding or subsequent examples or combination of examples, further comprising: determining the lifting system is in an unlocked position; transmitting a wireless signal from the lifting system to a device in response to determining the lifting system is in an unlocked position.

Example 20. The method of any of the preceding or subsequent examples or combination of examples, further comprising: receiving, by the device, the wireless signal; displaying a visual indication that the lifting system is in an unlocked position.

Example 21. The method of any of the preceding or subsequent examples or combination of examples, wherein the visual indication is a light.

Example 22. The method of any of the preceding or subsequent examples or combination of examples, wherein the visual indication is a written message.

Example 23. The method of any of the preceding or subsequent examples or combination of examples, further comprising: receiving, by the device, the wireless signal; outputting an auditory indication that the lifting system is in an unlocked position.

Example 24. A method of detaching a lifting apparatus from a load: positioning the load on a surface; actuating a shear pin of the lifting apparatus from a locked position in which the shear pin projects into an opening in an outer sleeve of the lifting system, to an unlocked position in which the shear pin does not project into the opening in the outer sleeve of the lifting apparatus; and disengaging a grip of the lifting apparatus from a connector of the load by lifting the lifting apparatus in a vertical direction.

Example 25. A method for attaching and lifting a load comprising: providing a lifting system including a lifting apparatus, the lifting apparatus comprising: an outer sleeve having an opening in a side of the outer sleeve; a inner unit having a chamber, a shear pin, an actuation device coupled to the shear pin for actuating the shear pin from a locked to an unlocked position, and a grip for coupling to a connector of a load, wherein in the unlocked position the shear pin is disengaged from the opening in the outer sleeve such that the outer sleeve may move relative to the inner unit; lowering the lifting system onto the load; positioning the inner unit of the lifting apparatus onto the load such that the inner unit is blocked from moving further in a downward direction; continuing to lower the outer sleeve of the lifting apparatus as the inner unit is retained in place by the load; automatically securing the grip of the lifting apparatus to the connector of the load via the downward movement of the outer sleeve as the inner unit is retained in place by the load; automatically actuating a shear pin from a released position to a locked position in which the shear pin projects into the opening in the outer sleeve of the lifting apparatus for securing the grip of the lifting apparatus to the connector of the load; and lifting the load by lifting the lifting system.

Example 26. A lifting apparatus comprising: a locking body; an actuator; a lever; and a gear, wherein, the lever is coupled between the actuator and the gear such that the lever rotates in response to the actuation of the actuator, and wherein the gear is coupled between the locking body and the lever such that the locking body moves in response to the rotation of the lever, wherein the locking body is movable between a first position and a second position in response to the actuation of the actuator.

Example 27. The lifting apparatus of any of the preceding or subsequent examples or combination of examples, further comprising a limit switch for indicating the position of the locking body.

Example 28. The lifting apparatus of any of the preceding or subsequent examples or combination of examples, wherein the actuator comprises a piston.

Example 29. The lifting apparatus of any of the preceding or subsequent examples or combination of examples, further comprising a second gear.

Example 30. The lifting apparatus of any of the preceding or subsequent examples or combination of examples, further comprising a transmitter for transmitting a wireless signal to a device in response to the limit switch indicating the locking body is in an unlocked position.

Example 31. The lifting apparatus of any of the preceding or subsequent examples or combination of examples, wherein the device comprises a mobile telephone.

Example 32. The lifting apparatus of any of the preceding or subsequent examples or combination of examples, wherein the wireless signal corresponds to a visual alert on the device.

Example 33. The lifting apparatus of any of the preceding or subsequent examples or combination of examples, wherein the visual alert is an illumination of a light.

Example 34. The lifting apparatus of any of the preceding or subsequent examples or combination of examples, further comprising a transmitter for transmitting a wireless signal to a device in response to the limit switch indicating the locking body is in a locked position.

Example 35. The lifting apparatus of any of the preceding examples, further comprising a receiver for receiving instructions regarding the actuation of the lifting apparatus from a device via a wireless signal.

Furthermore, relative terms such as, “lower”, “upper, “up”, “down”, “above”, “below,” “downward,” “upward” and the like are used herein to indicate directions and locations as they apply to the appended drawings and will not be construed as limiting the disclosure and features thereof to particular arrangements or orientations.

The foregoing description of the disclosure has been presented for the purposes of illustration and description and is not intended to be exhaustive or to limit the disclosure to the precise form disclosed. The described embodiments were chosen and described in order to best explain the principles of the disclosure and its practical application to thereby enable others skilled in the art to best utilize the disclosure in various embodiments and with various modifications as are suited to the particular use contemplated. Therefore, further modifications or improvements may be incorporated without departing from the scope of the disclosure herein intended.

1. A lifting apparatus comprising:
an outer sleeve having a first opening in a first side of the outer sleeve and a second opening in a second side of the outer sleeve;
an inner unit further comprising:
a chamber;
a first shear pin;
a second shear pin;
an actuation device coupled to the first and second shear pins for actuating the first and second shear pins from an extended to a retracted position; and
a bar positioned within and movable within a track, the bar further comprising a projection sized and shaped to engage with a slotted guide in a surface of the outer sleeve, wherein in an unlocked position in which the first and second shear pins are disengaged from the first and second openings in the outer sleeve, the outer sleeve may move relative to the inner unit.

2. The lifting apparatus of claim 1, wherein the bar is a semi-circular bar.

3. The lifting apparatus of claim 1, the inner unit further comprising a passive arm having a receiving aperture sized and shaped to receive the bar.

4. The lifting apparatus of claim 1, the inner unit further comprising an additional bar positioned and movable within an additional track, the additional bar further comprising an additional projection sized and shaped to engage with an additional slotted guide in a surface of the outer sleeve, wherein the bar and the additional are each semi-circular in shape.

5. The lifting apparatus of claim 1, the inner unit further comprising a first spring coupled to the first shear pin for applying a force to the first shear pin, and a second spring coupled to the second shear pin for applying a force to the second shear pin.

6. The lifting apparatus of claim 3, wherein in a locked position in which the first and second shear pins are engaged with the first and second openings in the outer sleeve, the outer sleeve may not move relative to the inner unit and the bar is locked in a latched position.

7. The lifting apparatus of claim 4, wherein in a locked position in which the first and second shear pins are engaged with the first and second openings in the outer sleeve, the outer sleeve may not move relative to the inner unit and an end of the bar overlaps with an end of the additional bar in a latched position.

8. The lifting apparatus of claim 7, wherein in the locked position a concave curve of the bar faces in an opposing direction from a concave curve of the additional bar such that a first end of the bar is engageable with a first lip of a box connector and a first end of the additional bar is engageable with a second lip of the box connector.

9. The lifting apparatus of claim 1, further comprising a transmitter for transmitting a wireless signal to a device, wherein the wireless signal corresponds to an indication of a locked or an unlocked position of the lifting apparatus.

10. The lifting apparatus of claim 1, further comprising a receiver for receiving a wireless signal from a device, wherein the wireless signal corresponds to an instruction for controlling the position of the lifting apparatus between a locked or an unlocked position.

11. A lifting system comprising:
a first lifting apparatus comprising:
a first outer sleeve having a first opening in a side of the first outer sleeve;
a first inner unit having a first chamber, a first shear pin, a first actuation device coupled to the first shear pin for actuating the first shear pin from a locked to an unlocked position, and a first grip for coupling to a first connector of a load, wherein in the unlocked position the first shear pin is disengaged from the opening in the first outer sleeve such that the first outer sleeve may move relative to the first inner unit;
a second lifting apparatus comprising
a second outer sleeve having a second opening in a side of the second outer sleeve;
a second inner unit having a second chamber, a second shear pin, a second actuation device coupled to the second shear pin for actuating the second shear pin from a locked to an unlocked position, and a second grip for coupling to a second connector of a load, wherein in the unlocked position the second shear pin is disengaged from the opening in the second outer sleeve such that the second outer sleeve may move relative to the second inner unit.

12. The lifting system of claim 11, further comprising:
a third lifting apparatus comprising
a third outer sleeve having a third opening in a side of the third outer sleeve;
a third lifting apparatus comprising:
a third inner unit having a third chamber, a third shear pin, a third actuation device coupled to the third shear pin for actuating the third shear pin from a locked to an unlocked position, and a third grip for coupling to a third connector of a load, wherein in the unlocked position the third shear pin is disengaged from the third opening in the third outer sleeve such that the third outer sleeve may move relative to the third inner unit.

13. A method for attaching and lifting a load comprising:
lowering a lifting system comprising a lifting apparatus onto a load;
positioning an inner unit of the lifting apparatus onto the load such that the inner unit is blocked from moving further in a downward direction;
continuing to lower an outer sleeve of the lifting system as the inner unit is retained in place by the load;
automatically securing a grip of the lifting apparatus to a connector of the load;
automatically actuating a shear pin from a released position to a locked position in which the shear pin projects into an opening in the outer sleeve of the lifting apparatus for securing the grip of the lifting apparatus to the connector of the load; and
lifting the load by lifting the lifting system.

14. The method of claim 13, further comprising:
positioning the load on a surface;
actuating the shear pin from the locked position to the released position in which the shear pin does not project into the opening in the outer sleeve of the lifting apparatus;
automatically disengaging the grip of the lifting system from the connector of the load by lifting the lifting apparatus in a vertical direction.

15. The method of claim 13, wherein the lifting system comprises an additional lifting apparatus for coupling to the load.

16. The method of claim 14, further comprising:
determining the lifting system is in an unlocked position;
transmitting a wireless signal from the lifting system to a device in response to
determining the lifting system is in an unlocked position.

17. The method of claim 16, further comprising:
receiving, by the device, the wireless signal;
displaying a visual indication that the lifting system is in an unlocked position, wherein the visual indication is a light or a written message.

18. The method of claim 16, further comprising:
receiving, by the device, the wireless signal;
outputting an auditory indication that the lifting system is in an unlocked position.

19. A method of detaching a lifting apparatus from a load:
positioning the load on a surface;
actuating a shear pin of the lifting apparatus from a locked position in which the shear pin projects into an opening in an outer sleeve of the lifting apparatus, to an unlocked position in which the shear pin does not project into the opening in the outer sleeve of the lifting apparatus; and
disengaging a grip of the lifting apparatus from a connector of the load by lifting the lifting apparatus in a vertical direction.

20. A method for attaching and lifting a load comprising:
providing a lifting system including a lifting apparatus, the lifting apparatus comprising:
an outer sleeve having an opening in a side of the outer sleeve;
a inner unit having a chamber, a shear pin, an actuation device coupled to the shear pin for actuating the shear pin from a locked to an unlocked position, and a grip for coupling to a connector of a load, wherein in the unlocked position the shear pin is disengaged from the opening in the outer sleeve such that the outer sleeve may move relative to the inner unit;
lowering the lifting system onto the load;
positioning the inner unit of the lifting apparatus onto the load such that the inner unit is blocked from moving further in a downward direction;
continuing to lower the outer sleeve of the lifting apparatus as the inner unit is retained in place by the load;
automatically securing the grip of the lifting apparatus to the connector of the load via downward movement of the outer sleeve as the inner unit is retained in place by the load;
automatically actuating a shear pin from a released position to a locked position in which the shear pin projects into the opening in the outer sleeve of the lifting apparatus for securing the grip of the lifting apparatus to the connector of the load; and
lifting the load by lifting the lifting system.

21. A lifting apparatus comprising:
a locking body;
an actuator;
a lever; and
a gear,
wherein, the lever is coupled between the actuator and the gear such that the lever rotates in response to the actuation of the actuator, and
wherein the gear is coupled between the locking body and the lever such that the locking body moves in response to the rotation of the lever,
wherein the locking body is movable between a first position and a second position in response to the actuation of the actuator.

22. The lifting apparatus of claim 21, further comprising a limit switch for indicating the position of the locking body.

23. The lifting apparatus of claim 21, wherein the actuator comprises a piston.

24. The lifting apparatus of claim 21, further comprising a second gear.

25. The lifting apparatus of claim 22, further comprising a transmitter for transmitting a wireless signal to a device in response to the limit switch indicating the locking body is in an unlocked position.

26. The lifting apparatus of claim 25, wherein the wireless signal corresponds to a visual alert on the device.

27. The lifting apparatus of claim 22, further comprising a transmitter for transmitting a wireless signal to a device in response to the limit switch indicating the locking body is in a locked position.

28. The lifting apparatus of claim 21 further comprising a receiver for receiving instructions regarding the actuation of the lifting apparatus from a device via a wireless signal.
